(19) United States
(12) Patent Application Publication
(10) Pub. No.: US 2021/0115271 A1
(43) Pub. Date: Apr. 22, 2021

(54) REFLECTIVE COATINGS AND IN-MOLD PROCESSES FOR THEIR APPLICATION TO POLYMER SUBSTRATES

(71) Applicant: Covestro LLC, Pittsburgh, PA (US)

(72) Inventors: James M. Lorenzo, Mars, PA (US); Jessee McCanna, Midland, PA (US); Timothy Frisch, New Albany, OH (US)

(21) Appl. No.: 16/604,628

(22) PCT Filed: Apr. 19, 2017
(86) PCT No.: PCT/US17/28252

§ 371 Date: Oct. 11, 2019

(51) Int. Cl. C09D 7/62; C09D 175/04; C08K 9/02; B05D 1/02; C09D 5/33

(52) U.S. Cl. CPC C09D 7/62; C09D 175/04; C08K 9/02; C08K 2003/0806; C09D 5/004; B05D 2201/02; B05D 1/02

(57) ABSTRACT

Reflective coatings comprise a transparent binder, such as polyurethane, one or more reflective additives, such as metal flakes, coated mica or titanium dioxide particles, and a phosphor. Such coatings may be applied to polymer substrates such as polycarbonate, without any additional reflective coating, film or layer. Processes for the mixing and applying the coatings area described, including introducing a polymer substrate into a mold cavity of a mold, introducing a coating composition into the mold cavity containing the polymer substrate in order to coat the substrate, at processing temperature 50° C.-120° C., at processing pressure 11,000 to 20,700 kPa, and curing the composition in the mold cavity at cure temperature of 62-105° C.

### FIELD

The present invention relates to reflective coatings and coated reflectors, such as those used in automotive lighting products employing light emitting diodes. In-mold processes for their application to polymer substrates are also described herein.

### BACKGROUND INFORMATION

Light emitting diodes, or LEDs, often emit a blue light. Phosphor absorbs blue light, and emits a yellow light. When a portion of the blue light emitted by the LED, mixes with the yellow light emitted by the phosphor, the mixture is perceived as a white light.

Automotive headlamps and other lights often work using reflectors. Reflectors may be solid shiny parts constructed of aluminum or other metals. Alternatively, reflectors may be molded plastic parts, which have a metallic coating on them, applied to reflect light generated by the light source. Processes for their application have been described in, e.g., Vakuumbeschichtung, vol. 1 to 5, H. Frey, VDI-Verlag Düsseldorf 1995, and Oberflächen-und Dünnschicht-Technologie, part 1, R.A. Haefer, Springer Verlag 1987.

In-mold coating is where a coating film is molded over the surface of a molded plastic substrate. In an in-mold coating method the molded plastic part is introduced into a cavity of the mold in which the coating film is injected. The mold may be a also multi-cavity metal mold, wherein the molded plastic part is formed in one cavity of the mold, before moving to a second cavity of the mold. Such a process can have advantages over a single cavity in-mold coating process. For example, cycle time is shorter since it is not composed of the sum of the times of the individual process steps and process parameters can be chosen independently for each cavity.

Two-component polyurethane forming coating compositions are widely used because of the many advantageous properties they exhibit. These coating compositions generally comprise a liquid binder component and a liquid hardener/crosslinker component. The liquid binder component may comprise an isocyanate-reactive component, such as a polyol, and the liquid crosslinker component may comprise a polyisocyanate. The addition reaction of the polyisocyanate with the isocyanate-reactive component, which can occur at ambient conditions, produces crosslinked polyurethane networks that form coating films.

It would be desirable to provide a coating composition that has both a metallic element to reflect the light, and phosphor to shift part of the light from blue to yellow, such that the resulting light appears to be white. It would be further desirable to apply a coating directly to a polymer substrate, without first having to add a metallic coating, and further, for it to be applied in a multi-cavity mold, where the polymer substrate may also be formed.

### SUMMARY

In an embodiment, a coating composition comprises (a) a transparent binder, (b) one or more reflective additives, and (c) a phosphor.

In another embodiment, a coated reflector comprises (a) a polymer substrate, and (b) a coating composition comprising a transparent binder, one or more reflective additives, and a phosphor.

In other embodiments of the coating composition or coated reflector, the polymer substrate comprises aromatic polycarbonate. In others, the transparent binder is a compound selected from the group consisting of: polyurethane, epoxy and silicone. In different embodiments, the transparent binder is a polyurethane comprising (i) a polymer comprising isocyanate-reactive groups, and (ii) a polyisocyanate. In more embodiments, one or more reflective additives are selected from the group consisting of metal flakes, coated mica and titanium dioxide, and if coated mica, then preferably the mica is coated with at least one compound selected from the group consisting of titanium dioxide and ferric oxide.

In more embodiments, the metal flakes may comprise at least one compound selected from the group consisting of Ag, Al, Ti, Cr, Cu, Va steel, Au, and Pt, preferably Ag, Al, Ti and Cr. Additionally, the coating composition may comprise 5 wt. % to 40 wt. % reflective additives. In other embodiments, the phosphor is selected from the group consisting of aluminate, silicate phosphor and cerium (III)-doped yttrium aluminum garnet. In more, the coating composition may comprise 10 wt. % to 60 wt. % phosphor.

In still more embodiments, the polymer substrate has not been metal coated. In others, there is no film, second coating or other layer containing metal flakes, or metal. In different embodiments, there is no reflective film, coating or other layer, in between the polymer substrate and the coating composition.

In another embodiment of the invention, a process for in-mold coating comprises (a) introducing a polymer substrate into a mold cavity of a mold, (b) introducing a coating composition into the mold cavity containing the polymer substrate in order to coat the substrate, (i) at processing temperature 50° C.-120° C., (ii) at processing pressure 11,000 to 20,700 kPa; and (c) curing the composition in the mold cavity at cure temperature of 62-105° C., wherein the coating composition comprises a transparent binder, one or more reflective additives and a phosphor, and wherein the polymer substrate has not been metal coated before being introduced into the mold cavity.

In an embodiment, the processing temperature is 60-76° C. In another, the processing pressure is 17,200 to 19,300 kPa. In yet another, the cure temperature is 71 to 82° C.

Another embodiment further comprises the step of mixing the polymer comprising an isocyanate-reactive resin and the polyisocyanate into a mixing head where the components are mixed before injection into the mold cavity. Another embodiment related to the above further comprises the step of mixing (i) the polymer comprising an isocyanate-reactive resin, reflective additives and phosphor, and (ii) the polyisocyanate, into a mixing head where the components are mixed before injection into the mold cavity. In another, one of the polymer comprising an isocyanate-reactive resin and the polyisocyanate is fed to the impingement mixing head through an orifice having a diameter of 0.15 mm-0.70 mm. In another, the polymer comprising isocyanate-reactive groups comprises: (i) an aromatic branched polyester polyol; and (ii) an aliphatic polycarbonate polyol, preferably a polycarbonate diol. In a different embodiment, the polyisocyanate comprises an isocyanurate of hexamethylene diisocyanate.

In another embodiment, the coating composition has a thickness of 0.05 mm to 3.5 mm, preferably, 0.1 mm-3.0 mm. In still another embodiment, the process further comprises molding a polymer substrate. In yet another embodiment, the mold comprises a first cavity and a second cavity, and the polymer substrate is molded in the first cavity and the coating composition is introduced in the second cavity.

In a different embodiment, there is no film, second coating or other layer containing metal flakes, or metal, that is added in between the polymer substrate and the coating composition. In another, there is no film, second coating or other reflective layer, that is added in between the polymer substrate and the coating composition.

### DETAILED DESCRIPTION

A coating described herein comprises a transparent binder, reflective additives and phosphor. The term “transparent” means that the binder should not optically interfere with the functions of reflective additives or the phosphor in the binder. The transparent binder may be polyurethane, epoxy, silicone, or another clear coating. The transparent binder may be a polyurethane, created from (i) a polymer comprising isocyanate-reactive groups, and (ii) a polyisocyanate. Additionally, the coating may be made from (i) a polymer comprising isocyanate-reactive groups, reflective additives and phosphor, and (ii) a polyisocyanate.

As used herein, “polymer” encompasses prepolymers, oligomers and both homopolymers and copolymers; the prefix “poly” in this context referring to two or more. As used herein, “molecular weight”, when used in reference to a polymer, refers to the number average molecular weight (“Mₙ”), unless otherwise specified. As used herein, the Mₙ of a polymer containing functional groups, such as a polyol, can be calculated from the functional group number, such as hydroxyl number, which is determined by end-group analysis, as is well known to those skilled in the art.

As used herein, the term “aliphatic” refers to organic compounds characterized by substituted or un-substituted straight, branched, and/or cyclic chain arrangements of constituent carbon atoms. Aliphatic compounds do not contain aromatic rings as part of the molecular structure thereof. As used herein, the term “cycloaliphatic” refers to organic compounds characterized by arrangement of carbon atoms in closed ring structures. Cycloaliphatic compounds do not contain aromatic rings as part of the molecular structure thereof. Therefore, cycloaliphatic compounds are a subset of aliphatic compounds. Therefore, the term “aliphatic” encompasses aliphatic compounds and/or cycloaliphatic compounds.

As used herein, “diisocyanate” refers to a compound containing two isocyanate groups. As used herein, “polyisocyanate” refers to a compound containing two or more isocyanate groups. Hence, diisocyanates are a subset of polyisocyanates.

The substrate may be created in a mold cavity by, for example, injection molding, injection compression molding, compression molding, reaction injection molding (RIM) or foaming. Thermoplastic and thermosetting plastics may be employed as substrate materials, specific examples of which include, but are not limited to, aromatic polycarbonate (PC), polyester, such as polybutylene terephthalate (PBT) or polyethylene terephthalate (PET), polyamide (PA), polyethylene (PE), polypropylene (PP), polystyrene (PS), poly(acrylonitrile-co-butadiene-co-styrene) (ABS), poly(acrylonitrile-co-styrene-co-acrylicester) (ASA), poly(styrene-acrylonitrile) (SAN), polyoximethylene (POM), cyclic polyolefine (COC), polyphenylenoxide (PPO), polymethylmethacrylat (PMMA), polyphenylensulfide (PPS), polyurethane (PUR), epoxy resins (EP), polyvinylchloride (PVC) and blends thereof. The substrate may be of any desired shape that the equipment can accommodate.

In certain embodiments, the molding of the substrate in the first mold cavity is carried out by the injection molding process from a thermoplastic. Suitable thermoplastics include, but are not limited to, PC, PBT, PA, PE, PP, PS, ABS, ASA, SAN, PET, POM, COC, PPO/PA or PPO/PS blends, PMMA, PPS thermoplastic polyurethane (TPU), EP, PVC and blends thereof.

In some embodiments of the present invention the molding of the substrate in the first mold cavity is conducted in the presence of a compound, such as a silicone, which has isocyanate-reactive functional groups, such as, for example, thiol, amine, and/or hydroxyl groups. As a result, such a compound can form part of the substrate itself and, since it includes groups reactive with isocyanate groups in the subsequently applied coating composition. It thereby, it is currently believed, can improve adhesion of the molded substrate to the coating. If the compound is a silicone, the silicone can act as a mold release agent that fosters release of the molded substrate from the first mold cavity. Examples of such compounds, which are suitable for use in the present invention include, but are not limited to, bis(3-aminopropyl) terminated poly(dimethylsiloxane) and polycaprolactone-poly(dimethylsiloxane).

According to embodiments of the process of the present invention, after the molding of the substrate, the substrate is then introduced into a mold. This mold may optionally be a second cavity of the same mold that was used to mold the substrate. The mold is opened and the substrate is transferred into a cavity. The transfer of the substrate may be carried out by any of a variety of methods. Specific examples of suitable methods include, but are not limited to, transfer with a rotary table, turning plate, sliding cavity and index plate as well as comparable methods in which the substrate remains on the core. If the substrate remains on the core for the transfer, this has the advantage that the position is also accurately defined after the transfer. On the other hand, methods for transfer of a substrate in which the substrate is removed from one cavity, e.g. with the aid of a handling system, and laid into another cavity are also suitable.

According to embodiments of the processes of the present invention, a coating composition is introduced into the mold cavity containing the molded polymer substrate in order to coat the substrate. The coating compositions utilized in the processes of the present invention may comprise: (i) a polymer comprising isocyanate-reactive groups; and (ii) a polyisocyanate. In certain embodiments, the coating composition is a high solids compositions, which, as used herein, means that the coating composition comprises no more than 10 wt. %, preferably not more than 2 wt. %, in particular not more than 1 wt. % of volatile materials (such as organic solvents or water) based on the total weight of the composition. In certain embodiments, the composition is a 100% solids composition that has a relatively low viscosity, which, as used herein means a viscosity at 23° C. of no more than 12,000 mPa·s, when measured according to DIN EN ISO 3219/A3 determined using a rotational viscometer—Visco Tester® 550, Thermo Haake GmbH), hydroxyl content of 15.4-16.6% (measured according to DIN 53 240/2).

Suitable polymers comprising isocyanate-reactive groups include, for example, polymeric polyols, such as, for example, polyether polyols, polyester polyols, and/or polycarbonate polyols, among others.

Suitable polyether polyols, include, without limitation, those having a Mₙ of 100 to 4,000 g/mol. Polyether polyols which are formed from recurring ethylene oxide and propylene oxide units are sometimes used, such as those having a content of from 35 to 100% of propylene oxide units, such as 50 to 100% of propylene oxide units. These can be random copolymers, gradient copolymers or alternating or block copolymers of ethylene oxide and propylene oxide. Suitable polyether polyols derived from recurring propylene oxide and/or ethylene oxide units are commercially available and include, for example, those available from, for example, Covestro LLC, Pittsburgh, Pa. (such as e.g. Desmophen® 3600Z, Desmophen® 1900U, Acclaim® Polyol 2200, Acclaim® Polyol 40001, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004, Polyether® S180).

The polymeric polyol comprises a polyester polyol, such as those having a Mₙ of 200 to 4,500 g/mol. Preferably, the polyester polyol has a viscosity at 23° C. of 700 to 50,000 mPa·s and a hydroxyl number of 200 to 800 mg KOH/g. The polyester polyol may be based on an aromatic carboxylic polyester with an average hydroxyl functionality of greater than 2, such as 3 or more, and an average hydroxyl number of 350 to 700 mg KOH/g, such as 450 to 600 mg/KOH/g and a viscosity at 23° C. of 1000 to 30000 mPa·s. Suitable polyester polyols can be prepared, as will be appreciated, by reacting polyhydric alcohols with stoichiometric amounts of polybasic carboxylic acids, carboxylic anhydrides, lactones or polycarboxylic acid esters of C₁-C₄ alcohols.

The polyester polyol may be derived from one or more of aromatic polybasic carboxylic acids or their anhydride, ester derivatives, ε-caprolactone, optionally in a mixture with one or more aliphatic or cycloaliphatic polybasic carboxylic acids or their derivatives.

Suitable compounds having a number average molecular weight from 118 to 300 g/mol and an average carboxyl functionality >2, which are suitable for use in preparing the polyester polyol, include, but are not limited to adipic acid, phthalic anhydride, and isophthalic acid, or a mixture thereof is used.

For the preparation of the polyester polyols, suitable polyhydric alcohols, in some embodiments, those having a number average molecular weight of 62-400 g/mol, such as 1,2-ethanediol, 1,2 and 1,3-propanediol, the isomeric butanediols, pentanediols, hexanediols, heptanediols, and octanediols, 1,2, and 1,4-cyclohexanediol, 1,4-cyclohexanedimethanol, 4,4′- (1-methylethylidene)-biscyclohexanol, 1,2,3-propanetriol, 1,1,1-trimethylolethane, 1,2,6-hexanetriol, 1,1,1-trimethylolpropane, 2,2 (bis(hydroxymethyl)-1,3-propanediol. In certain embodiments, the polyhydric alcohol comprises 1,2-propanediol, 1,3-butanediol, 1,6-hexanediol, neopentyl glycol and/or trimethylolpropane, such as 1,3-butanediol, neopentyl glycol and/or trimethylolpropane. In certain embodiments, the polyester polyol comprises a branched polyester polyol, an example of which is Desmophen® XP 2488, available from Covestro LLC, Pittsburgh, Pa.

In certain embodiments of the present invention, the polymeric polyol comprises an aliphatic polycarbonate polyol, such as a polycarbonate diol, such as those having a Mₙ of 200 to 5000 gram/mole, such as 150 to 4,500 gram/mole, 300 to 2000 gram/mole, 300 to 2,500 gram/mole or 400 to 1000 gram/mole, and a hydroxyl functionality of 1.5 to 5, such as 1.7 to 3 or 1.9 to 2.5. Such polycarbonate polyols can, in certain embodiments, also have a viscosity at 23° C. of 2000 to 30,000 mPa·s, such as 2500 to 16000 mPa·s or 3000 to 5000mPa·s, when measured according to DIN EN ISO 3219/A3 determined using a rotational viscometer—Visco Tester® 550, Thermo Haake GmbH, a hydroxyl content of 15.4-16.6% (measured according to DIN 53 240/2), and/or a hydroxyl number of 40 to 300 mg KOH/gram, such as 50 to 200 mg KOH/gram or 100 to 200 mg KOH/gram, when measured by end-group analysis as is well understood in the art.

Such aliphatic polycarbonate polyols can be prepared, for example, by tranesterification of monomeric dialkyl carbonates, such as dimethyl carbonate, diethyl carbonate or diphenyl carbonate with polyols having a hydroxyl functionality of at least 2.0, such as, for example, 1,4-butanediol, 1,3-butanediol, 1,5-pentanediol, 1,6-hexanediol, 3-methyl-1,5-pentanediol, 1,12-dodecanediol, cyclohexanediomethylol, trimethylolpropane, and/or mixtures of any of these with lactones, such as ε-caprolactone. In certain embodiments of the present invention, the aliphatic polycarbonate polyol is prepared from 1,4-butanediol, 1,6-hexanediol, 3-methyl-1,5-pentanediol, or a mixture of two or more thereof with ε-caprolactone. For example, the Desmophen® C types from Covestro LLC, Pittsburgh, Pa., such as, for example, Desmophen® C 1100 or Desmophen C 2200, can be used as polycarbonate diols.

In certain embodiments of the present invention, the polymer comprising isocyanate-reactive groups comprises (i) a polyester polyol, such as a branched polyester polyol, and (ii) a polycarbonate polyol, such as a polycarbonate diol, such as a polycarbonate polyester diol, such as those based on 1,6-hexanediol and ε-caprolactone. In certain embodiments, the weight ratio of (i) and (ii) in the coating compositions used in the processes of the present invention is in the range of 1:10 to 10:1, such as 1:5 to 5:1, 1:4 to 4:1, 1:3 to 3:1, 1:2 to 2:1, or, in some cases, it is 1:1. In certain embodiments, the polymer comprising isocyanate-reactive groups (or mixture of two or more such polymers as described above) is selected so as to have a relatively low viscosity at 23° C. (measured according to DIN EN ISO 3219/A.3), preferably no more than 10,000 mPa·s, or, in particular, no more than 9,000 or no more than 8,000 mPa·s.

As indicated, the coating compositions used in the process of the present invention further comprise a polyisocyanate. Suitable polyisocyanates include aromatic, araliphatic, aliphatic or cycloaliphatic di- and/or polyisocyanates and mixtures thereof. In certain embodiments, the polyisocyanate comprises a diisocyanates of the formula R(NCO)₂, wherein R represents an aliphatic hydrocarbon residue having 4 to 12 carbon atoms, a cycloaliphatic hydrocarbon residue having 6 to 15 carbon atoms, an aromatic hydrocarbon residue having 6 to 15 carbon atoms or an araliphatic hydrocarbon residue having 7 to 15 carbon atoms. Specific examples of suitable diisocyanates include xylylene diisocyanate, tetramethylene diisocyanate, 1,4-diisocyantobutane, 1,12-diisocyanatododecane, hexamethylene diisocyanate, 2,3,3-trimethylhexamethylene diisocyanate, 1,4-cyclohexylene diisocyanate, 4,4′-dicyclohexylmethane diisocyanate, 4,4′-dicyclohexyl diisocyanate, 1-diisocyanato-3,3,5-trimethyl-5-isocyanatomethylcyclohexane- (isophorone diisocyanate), 1,4-phenylene diisocyanate, 2,6-tolylene diisocyanate, 2,4-tolylene diisocyanate, 1,5-naphthylene diisocyanate, 2,4′- or 4,4′-diphenylmethane diisocyanate, 4,4′-diphenyldimethylmethane diisocyanate, α,α,α′,α′-tetramethyl-m- or -p-xylylene diisocyanate, and triphenylmethane 4,4′,4″-triisocyanate as well as mixtures thereof. Also suitable are monomeric triisocyanates such as 4-isocyanatomethyl-1,8-octamethylene diisocyanate.

Polyisocyanate adducts containing isocyanurate, iminooxadiazine dione, urethane, biuret, allophanate, uretidione and/or carbodiimide groups are also suitable for use in the coating compositions used in the processes of the present invention. Such polyisocyanates may have isocyanate functionalities of 3 or more and can be prepared, for example, by the trimerization or oligomerization of diisocyanates or by the reaction of diisocyanates with polyfunctional compounds containing hydroxyl or amine groups. In one particular embodiment, the polyisocyanate is the isocyanurate of hexamethylene diisocyanate, which may be prepared in accordance with U.S. Pat. No. 4,324,879 at col. 3, line 5 to col. 6, line 47, the cited portion of which being incorporated herein by reference.

The coating composition may comprise a low viscosity polyisocyanate having a viscosity at 23° C. and at 100% solids of less than 2000 mPa·s, such as less than 1500 mPa·s or, in some cases, 800 to 1400 mPa·s, when measured according to DIN EN ISO 3219/A3 determined using a rotational viscometer—Visco Tester® 550, Thermo Haake GmbH; an isocyanate group content of 8.0 to 27.0 wt. %, such as 14.0-24.0 wt. % or 22.5-23.5% (according to DIN EN ISO 11909); an NCO calculated functionality of 2.0 to 6.0, such as 2.3 to 5.0 or 2.8 to 3.2; and a content of monomeric diisocyanate of less than 1 wt. %, such as less than 0.5 wt. %.

Examples of these polyisocyanates include isocyanurate group-containing polyisocyanates prepared by trimerizing hexamethylene diisocyanate until the reaction mixture has an NCO content of 42 to 45, such as 42.5 to 44.5 wt. %, subsequently terminating the reaction and removing unreacted hexamethylene diisocyanate by distillation to a residual content of less than 0.5 wt. %; uretdione group-containing polyisocyanates which may present in admixture with isocyanurate group-containing polyisocyanates; biuret group-containing polyisocyanates which may be prepared according to the processes disclosed in U.S. Pat. Nos. 3,124,605; 3,358,010; 3,903,126; and 3,903,127; isocyanurate and allophanate group-containing polyisocyanates which may be prepared in accordance with the processes set forth in U.S. Pat. Nos. 5,124,427, 5,208,334 and 5,235,018; and iminooxadiazine dione and optionally isocyanurate group-containing polyisocyanates which may be prepared in the presence of special fluorine-containing catalysts as described in DE-A 19611849.

Cyclic and/or linear polyisocyanate molecules may usefully be employed. For improved weathering and diminished yellowing the polyisocyanate(s) of the isocyanate component is typically aliphatic.

The polyisocyanate may comprise, or, in some cases, may consist essentially of, or may consist of, a polyisocyanate containing biuret groups, such as the biuret adduct of hexamethylene diisocyanate (HDI) available from Covestro LLC under the trade designation Desmodur® N-100, a polyisocyanate containing isocyanurate groups, such as that available from Covestro LLC under trade designation Desmodur® N-3300, and/or a polyisocyanate containing urethane groups, uretdione groups, carbodiimide groups, allophonate groups, and the like. These derivatives are preferred as they are polymeric, exhibit very low vapor pressures and are substantially free of isocyanate monomer.

The pre-reaction of the polyisocyanate with hydroxy group-containing material results in the modified polyisocyanate having a higher molecular weight and lower isocyanate content than the polyisocyanate alone. This will often lead to a higher viscosity in the modified polyisocyanate. It is often desirable that the modified polyisocyanate is low in viscosity, such as those in which the Brookfield viscosity is less than about 10,000 cps, such as less than 5,000 cps, or, in some cases, less than 4,000 cps at temperatures ranging from 25° C. to 70° C. Exemplary such polyisocyanates include those commercially available from Covestro LLC under the tradename Desmodur® N-3600, which has a viscosity of 800-1400 mPa·s at 25° C.

In forming the coating compositions, the polymer(s) comprising isocyanate-reactive groups, such as the polyol(s) mentioned earlier and the polyisocyanate(s) may be combined in relative amounts such that the coating composition has a ratio of isocyanate groups to isocyanate-reactive groups of 0.8 to 3.0:1, such as 0.8 to 2.0:1, or, in some cases, 1:1 to 1.8:1 or 1:1 to 1.5:1. In some embodiments, this ratio is greater than 1:2:1, such as at least 1:3:1 and/or up to 1:4:1. Indeed, it is currently believed that such “over-indexing” of isocyanate groups to isocyanate-reactive groups can be a significant contributor to the ability of a coated molded substrate to de-mold from the second mold cavity via gravity alone or with suction alone after the coating composition has cured, since, under the elevated temperature and elevated pressure cure conditions used in the processes of the present invention all, or substantially all, of the isocyanate-reactive groups, such as hydroxyl groups, are thought to either cure by exposure to moisture or form allophonate groups, thereby providing a more complete cure of the coating composition.

The coating compositions may further comprise a catalyst for the reaction between the isocyanate-reactive group, such as the hydroxyl group, and the isocyanate group. Suitable such catalysts include metallic and nonmetallic catalysts, specific examples of which include, but are not limited to, amine catalysts, such as 1,8-diazabicyclo[5.4.0]undec-7-ene (DBU), 1,4-diazabicyclo[2.2.2]octane (DABCO) or triethanolamine, and Lewis acid compounds, such as dibutyltin dilaurate, lead octoate, tin octoate, titanium and zirconium complexes, cadmium compounds, bismuth compounds, such as bismuth neodecanoate and iron compounds. In certain embodiments, the catalyst is present in the coating composition in an amount of no more than 1.0 wt. %, based on the total solids contents of the composition.

The coating compositions further comprise one or more reflective additives. Reflective additives used in association with the present invention include metal flakes, coated mica and titanium dioxide particles. Mica may be coated with titanium dioxide and/or ferric oxide. The titanium dioxide particles are preferably spherical. The reflective additives may be sized to work with equipment, and in particular, orifices used in preparing and mixing the compositions described hereinbelow to ensure adequate mixing within the compositions. The metals used may be Ag, Al, Ti, Cr, Cu, Va steel, Au, or Pt, particularly preferably Ag, Al, Ti or Cr. Alternatively, mica coated with titanium dioxide and ferric oxide may be used, sold under the tradename Iriotec 8805 by EMD Performance Materials, Philadelphia, Pa. The coating may comprise 5 wt. % to 40 wt. % reflective additives.

The coating compositions further comprise a phosphor. The phosphor may be one or more compounds selected from a group consisting of aluminate, silicate phosphor and cerium (III)-doped yttrium aluminum garnet. Such compounds are commercially available under the tradenames GAL and EY4156, from Intematix, Freemont, Calif., and also under the tradenames HTY550 and HTY560 by PhosphorTech Corporation, Kennesaw, Ga. The coating may comprise 10 wt. % to 60 wt. % phosphor.

The coating compositions used in the process of the present invention may further comprise a plasticizer, used to lower the viscosity of the composition. The plasticizer is preferably phthalate-free, such as alkylsulphonic acid ester with phenol, sold under the trademark Mesamoll by LANXESS Deutschland GmbH, Leverkusen, Germany.

The coating compositions of the present invention may comprise a silicone, which can act as an internal mold release agent in the coating composition, thereby facilitating the release of the cured coating from a mold cavity by force of gravity alone or with suction alone when the mold is opened. The silicone may be a polyether-modified silicone compound, as such compounds tend to increase the likelihood that the coated molded substrate will release from a mold cavity by the force of gravity alone or with suction alone when the mold is opened.

Examples of polyether-modified silicones suitable for use in the present invention include compounds in which a polyether chain is included at ends and/or side chains of a polysiloxane, and also includes a co-modified silicon compound in which a different organic group is also included into polysiloxane. It is also possible that the polyether-modified silicone include a (meth)acryloyl group in a molecule.

Examples of polyether-modified silicone compounds, which are suitable for use in the present invention include, but are not limited to, BYK® silicones, such as, but not limited to BYK®-377, which is a solvent-free polyether-modified, hydroxyl-functional polydimethylsiloxane, from BYK USA Inc.

Examples of other internal mold release agents, which are suitable for use in the present invention, include polyester-modified silicone compounds in which a polyester chain is included at ends and/or side chains of a polysiloxane, and also includes a co-modified silicon compound in which a different organic group is also included together into polysiloxane. It is also possible that the polyester modified silicone include a (meth)acryloyl group in a molecule.

Examples of polyester-modified silicone compounds, which are suitable for use in the present invention, include, but are not limited to, BYK® silicones, such as, but not limited to BYK-370, which is a solution of a polyester-modified, hydroxyl-functional polydimethylsiloxane, 75% solids content in xylene, alkylbenzes, cyclohexanone, and monophenyl glycol, from BYK USA Inc.

An internal mold release agent, such as the foregoing silicones, may be present in the composition in an amount of 0.1 to 5% by weight, such as 0.1 to 1.0 percent by weight, based on the total weight of the coating composition. In certain embodiments of the present invention, the internal mold release agent is present in the composition in an amount sufficient to provide a cured coating with a surface tension of no more than 30 dynes/cm, such as no more than 25 dynes/cm when measured using a Ramé-Hart goniometer in which total solid surface energies, including the polar and dispersive components are calculated using the advancing angles according to the Owens Wendt procedure and in which samples are stacked together without surface protection and the surfaces are lightly brushed to remove dust prior to analysis.

The coating compositions used in the processes of the present invention may comprise any customary auxiliaries and additives of paint technology, such as UV stabilizer additives, defoamers, thickeners, pigments, dispersing assistants, catalysts, anti-skinning agents, anti-settling agents or emulsifiers, for example.

The coating compositions may be employed using a variety of methods, including flow coating, spray coating, dip coating, and direct coating within a mold cavity. Of these, the direct coating within a mold cavity is preferred, and is described in detail herein.

In direct coating, the coating composition is introduced into a mold cavity containing the molded polymer substrate in order to coat the substrate, and the composition is cured in the mold cavity at cure conditions of an elevated pressure and temperature. If two-component coating compositions are employed, particularly those with a short pot life due to the presence of a sufficient amount of cure catalyst, these components may be mixed thoroughly either in an injection nozzle, such as a high pressure counter-current mixing head, or in the feed line by a static mixer or active mixing with the aid of a dynamic mixer, depending on the pot life and installation technology. If the pot life is long due, for example, to the absence of any cure catalyst or a sufficiently low amount of cure catalyst, mixing of the two components may also be carried out outside the installation and the mixture can be processed like a one-component system. In this case, for example, the processing time may be prolonged by cooling the components before injection, and a short reaction time may be achieved by increasing the mold temperature in the cavity.

In embodiments of the present invention, the coating step is carried out under pressure. This means that the application of the coating composition to the molded polymer substrate is carried out under pressure. In certain embodiments, the coating is applied by injecting the coating composition under pressure into the gap between the surface of the substrate and the inner wall of the cavity. The pressure is high enough for the cavity, which is pressurized due to an external pressure device, such as clamps (as described in more detail below), to be filled before the end of the pot life of the coating composition is reached. At the same time, the pressure prevents the formation of bubbles at the flow front of the coating composition.

In a preferred embodiment, the coating is applied to a polymer substrate that has not been metal coated. Preferably, there is no film, second coating or other layer containing metal flakes, or even any metal at all, that is added to the substrate before the coating is applied. In this embodiment, the only reflector that is present is in the inventive coating; the coated reflector does not include any other coating, film or layer that may be used as a reflector, disposed in between the polymer substrate and the coating composition.

Curing of the coating composition is also carried out under pressure. In the context of the present invention, curing of the coating composition means that the coating has cured to an extent sufficient so that upon opening of the mold, the coated molded substrate releases, i.e., demolds, from the mold by the force of gravity alone or with suction alone when the mold is opened. At the end of the curing time, the pressure in the cavity may have fallen to ambient pressure.

Several factors contribute to the ability to conduct an in-mold coating process in which upon opening a mold cavity, the coated polymer substrate releases, i.e., demolds, from the internal surface of the second mold by the force of gravity alone or, at most, a suction force alone when the mold is opened, and without any additional force or effort being required to remove the coated molded substrate from the cavity. In particular, a combination of mold temperature, external mold pressure, cure time, the composition of the coating itself (including the presence of an internal mold release agent as described above and the ratio of isocyanate groups to isocyanate-reactive groups described earlier), and the presence of the external mold release agent described below each can be a significant contributor to the ability of a coated molded substrate to de-mold from the second mold cavity via gravity alone or with suction alone after the coating composition has cured and the mold is opened.

More particularly, the coating composition (including the presence of an internal mold release agent as described above and the ratio of isocyanate groups to isocyanate-reactive groups described earlier) and the selected combination of cure time, mold temperature and external mold pressure used are selected so that urea groups of the polyurethanes chains in the cured coating are crosslinked with one another in the coating, thereby increasing the crosslink density of the polyurethane polymeric network. It is believed that this crosslinking of the polyurethane chains can be measured by analyzing the content of free urea groups in the cured coating when the mold is opened.

The coating composition is injected into a mold cavity. The mold cavity may be of any desired design, so that the coating layer is, if desired, the same thickness over the entire surface of the substrate, also known as a “conformal coating.” In other cases, if desired, the cavity may be shaped such that the coating layer is of a different thickness in various regions of the substrate, such having one thickness when it is encapsulating a sensitive additional component, and another when it is only covering the substrate. For example, the mold cavity may be shaped to give a substantially smooth surface at a constant distance from the substrate, even in places where the substrate includes additional components. This also is known as a “non-conformal coating.” In some cases, the mold cavity may have a textured surface or may have a desired design or logo that is sought to be included in the coating. The desired coating layer thickness may be achieved at any point of the substrate in this manner In certain embodiments of the present invention, an external release agent is present on the surface of one or both of the cavities. In particular, a coating comprising electroless nickel and polytetrafluoroethylene (PTFE) is suitable as an external release agent. Such a coating is commercially available under the tradename Poly-Ond® from Poly-Plating, Inc. In certain embodiments of the present invention, the mold cavity is designed such that the dry film thickness of the coating layer that is produced is 0.05 to 3.5 millimeters, preferably 0.1 to 3.0 millimeters.

Injection of the coating composition into the mold cavity can be accomplished via injection of the composition into the cavity via one or more nozzles such that the gap between the surface of the molded substrate and mold inner wall is filled completely with the coating composition. For an optimum injection of the coating composition, the number and position of the injection points can be chosen appropriately in a manner known to the person skilled in the art. The mold cavity may be designed so as to provide a controlled displacement of the air present in the cavity and its removal via a parting line or venting channels during the injection. Known calculation programs may be used for this. The sprue design for injection of the coating composition may be, e.g., according to the sprue variants known from the prior art for the production of RIM moldings.

In certain embodiments, the coating is carried out by the RIM process with a single cavity. This has the advantage that the two components of the two-component of the coating composition are combined only immediately before injection into the cavity. In certain embodiments, this is accomplished by feeding (i) a component comprising an isocyanate-reactive resin (as described above), the reflective additives and the phosphor, and (ii) a component comprising a polyisocyanate (as described above) from a RIM installation into an impingement mixing head where the components are mixed before injection into the mold cavity. Typically each of the components is fed to the impingement mixing head through an orifice having a diameter of 0.15 mm-0.70 mm.

In embodiments of the present invention, the mixture is injected into the second mold cavity at a flow rate of 10-60 grams/second, preferably 15-20 grams/second, at a line pressure of 1600 to 3000 psi (11,000 to 20,700 kPa), preferably 2500 to 2800 psi (17,200 to 19,300 kPa) and at a temperature of 50-120° C. (120-248° F.), preferably 60-76° C. (140-170° F.).

Once the coating composition is in the mold cavity, it is exposed to cure conditions of elevated temperature and external mold pressure.

Suitable mold cure temperatures for use in the present invention range, for example, from 62 to 105° C., preferably 71 to 82° C. (160-180° F.). As used herein, “external mold pressure” means the externally applied pressure applied against the opposing faces of the mold (in which the cavity is disposed) when the opposing faces of the mold are forced together. The source of such pressure can be clamps, rams, or another device. In certain embodiments, the external mold pressure is at least 100 kg/mm² (9807 bar), such as at least 110 (10787 bar), or at least 120 kg/mm² (11768 bar). In certain of these embodiments, the external mold pressure is no more than 200 kg/mm² (19613 bar), such as no more than 180 (17652 bar) or no more than 160 kg/mm² (15691 bar). The external mold pressure, in certain embodiments, is maintained relatively constant through the coating cure process. In certain embodiments, the cure time is 10-30 seconds, in others it is 30-60 seconds, or 60-90 seconds. In an additional embodiment, the cure time is 90-120 seconds.

As will be appreciated, the process according to the invention may also be carried out in a mold having more than the two cavities. Thus, for example, the additional components may be applied in another cavity. Also, further coating layers with optionally specific properties may be applied by applying each coating layer in its own cavity. It is furthermore possible to produce several molded polymer substrates in parallel in one cavity each and then to coat these successively in one cavity or in parallel in one cavity each.

The injection molding device of the mold according to the invention serves for the production of the substrate from a thermoplastic or thermosetting by means of injection molding in a first cavity of the mold. Suitable injection molding devices are known to the person skilled in the art. They include a standard injection molding machine construction comprising a plasticating unit for processing of the substrate and a closing unit, which is responsible for the travelling, opening and closing movement of the mold, temperature control apparatuses and optionally drying apparatuses for the substrate.

The coating injection device, which is connected to a second cavity in the mold according to the invention, serves for coating of the substrate. Suitable coating injection devices can include one or more reservoir containers for the individual components, stirrers, feed pumps, temperature control devices for establishing the temperature, feed lines and optionally a mixing device for mixing more than one coating component, e.g., a mixing head for high pressure counter-jet mixing.

The coated molded polymer substrate produced by the processes of the present invention are suitable, for a wide variety of applications requiring a coating, or encapsulation, of delicate additional components that may otherwise be damaged by following a coating process of the prior art.

In addition, the following aspects of the invention are listed as follows:

1. A coating composition comprising:
(a) a transparent binder;
(b) one or more reflective additives; and
(c) a phosphor.
2. A coated reflector comprising:
(a) a polymer substrate; and
(b) a coating composition comprising a transparent binder, one or more reflective additives, and a phosphor.
3. A process for in-mold coating comprising:
(a) introducing a polymer substrate into a mold cavity of a mold;
(b) introducing a coating composition into the mold cavity containing the polymer substrate in order to coat the substrate,
(i) at processing temperature 50° C.-120° C.,
(ii) at processing pressure 11,000 to 20,700 kPa; and
(c) curing the composition in the mold cavity at cure temperature of 62-105° C.;
wherein the coating composition comprises a transparent binder, one or more reflective additives and a phosphor; and
wherein the polymer substrate has not been metal coated before being introduced into the mold cavity.
4. Any of the preceding aspects, wherein the transparent binder is a compound selected from the group consisting of: polyurethane, epoxy and silicone.
5. Any of the preceding aspects, wherein the transparent binder is a polyurethane comprising (i) a polymer comprising isocyanate-reactive groups, and (ii) a polyisocyanate.
6. Any of the preceding aspects, wherein the one or more reflective additives are selected from the group consisting of metal flakes, coated mica and titanium dioxide.
7. Any of the preceding aspects, wherein the coated mica is mica coated with at least one compound selected from the group consisting of: titanium dioxide and ferric oxide.
8. Any of the preceding aspects, wherein the metal flakes comprises at least one compound selected from the group consisting of: Ag, Al, Ti, Cr, Cu, Va steel, Au, and Pt, preferably Ag, Al, Ti and Cr.
9. Any of the preceding aspects, wherein the coating composition comprises 5 wt. % to 40 wt. % reflective additives.
10. Any of the preceding aspects, wherein the phosphor is selected from the group consisting of aluminate, silicate phosphor and cerium (III)-doped yttrium aluminum garnet.
11. Any of the preceding aspects, wherein the coating composition comprises 10 wt. % to 60 wt. % phosphor.
12. Any of the preceding aspects, wherein the polymer substrate comprises aromatic polycarbonate.
13. Any of the preceding aspects, wherein the polymer substrate has not been metal coated.
14. Any of the preceding aspects, wherein there is no film, second coating or other layer containing metal flakes, or metal.
15. Any of the preceding aspects, wherein there is no reflective film, coating or other layer, in between the polymer substrate and the coating composition.
16. Any of the preceding aspects, wherein the processing temperature is 60-76° C.
17. Any of the preceding aspects, wherein the processing pressure is 17,200 to 19,300 kPa.
18. Any of the preceding aspects, wherein the cure temperature is 71 to 82° C.
19. Any of the preceding aspects, further comprising the step of mixing the polymer comprising an isocyanate-reactive resin and the polyisocyanate into a mixing head where the components are mixed before injection into the mold cavity.
20. Any of the preceding aspects, further comprising the step of mixing (i) the polymer comprising an isocyanate-reactive resin, reflective additives and phosphor, and (ii) the polyisocyanate, into a mixing head where the components are mixed before injection into the mold cavity.
21. Any of the preceding aspects, wherein one of the polymer comprising an isocyanate-reactive resin and the polyisocyanate is fed to the impingement mixing head through an orifice having a diameter of 0.15 mm-0.70 mm.
22. Any of the preceding aspects, wherein the polyisocyanate comprises an isocyanurate of hexamethylene diisocyanate.
23. Any of the preceding aspects, wherein the coating composition has a thickness of 0.05 mm to 3.5 mm, preferably, 0.1 mm-3.0 mm.
24. Any of the preceding aspects, further comprising molding a polymer substrate.
25. Any of the preceding aspects, wherein the mold comprises a first cavity and a second cavity, and the polymer substrate is molded in the first cavity and the coating composition is introduced in the second cavity.

1. A coating composition comprising:
(a) a transparent binder;
(b) one or more reflective additives; and
(c) a phosphor.

2. The composition of claim 1, wherein the transparent binder is a compound selected from the group consisting of: polyurethane, epoxy and silicone.

3. The composition of claim 1, wherein the transparent binder is a polyurethane comprising (i) a polymer comprising isocyanate-reactive groups, and (ii) a polyisocyanate.

4. The composition of claim 1, wherein the one or more reflective additives are selected from the group consisting of metal flakes, coated mica and titanium dioxide.

5. The composition of claim 4, wherein the coated mica is mica coated with at least one compound selected from the group consisting of: titanium dioxide and ferric oxide.

6. The composition of claim 4, wherein the metal flakes comprises at least one compound selected from the group consisting of: Ag, Al, Ti, Cr, Cu, Va steel, Au, and Pt.

7. The composition of claim 4, wherein the metal flakes comprises at least one compound selected from the group consisting of: Ag, Al, Ti and Cr.

8. The composition of claim 1, wherein the composition comprises 5 wt. % to 40 wt. % reflective additives.

9. The composition of claim 1, wherein the phosphor is selected from the group consisting of aluminate, silicate phosphor and cerium (III)-doped yttrium aluminum garnet.

10. The composition of claim 1, wherein the composition comprises 10 wt. % to 60 wt. % phosphor.

11. A coated reflector comprising:
(a) a polymer substrate; and
(b) a coating composition comprising a transparent binder, one or more reflective additives, and a phosphor.

12. The coated reflector of claim 11, wherein the polymer substrate comprises aromatic polycarbonate.

13. The coated reflector of claim 11, wherein the transparent binder is a compound selected from the group consisting of: polyurethane, epoxy and silicone.

14. The coated reflector of claim 11, wherein the transparent binder is a polyurethane comprising (i) a polymer comprising isocyanate-reactive groups, and (ii) a polyisocyanate.

15. The coated reflector of claim 11, wherein the one or more reflective additives are selected from the group consisting of metal flakes, coated mica and titanium dioxide.

16. The coated reflector of claim 15, wherein the coated mica is mica coated with at least one compound selected from the group consisting of: titanium dioxide and ferric oxide.

17. The coated reflector of claim 15, wherein the metal flakes comprises at least one compound selected from the group consisting of: Ag, Al, Ti, Cr, Cu, Va steel, Au, and Pt.

18. The coated reflector of claim 15, wherein the metal flakes comprises at least one compound selected from the group consisting of: Ag, Al, Ti and Cr.

19. The coated reflector of claim 11, wherein the coating composition comprises 5 wt. % to 40 wt. % reflective additives.

20. The coated reflector of claim 11, wherein the phosphor is selected from the group consisting of aluminate, silicate phosphor and cerium (III)-doped yttrium aluminum garnet.

21. The coated reflector of claim 11, wherein the coating composition comprises 10 wt. % to 60 wt. % phosphor.

22. The coated reflector of claim 11, wherein the polymer substrate has not been metal coated.

23. The coated reflector of claim 11, wherein there is no film, second coating or other layer containing metal flakes, or metal.

24. The coated reflector of claim 11, wherein there is no reflective film, coating or other layer, in between the polymer substrate and the coating composition.

25-40. (canceled)
